(19) United States
(12) Patent Application Publication
(10) Pub. No.: US 2005/0196619 A1
(43) Pub. Date: Sep. 8, 2005

(54) Flame retardant adhesive composition, and adhesive sheet, coverlay film and flexible copper-clad laminate using same

(75) Inventors: Toru Nakanishi, Setagaya-ku (JP); Hitoshi Arai, Kashima-gun (JP); Michio Aizawa, Chiba-shi (JP); Tadashi Amano, Kashima-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 11/071,154

(22) Filed: Mar. 4, 2005

(30) Foreign Application Priority Data
Mar. 5, 2004 (JP) 2004-061670

(51) Int. Cl. B32B 27/38

(52) U.S. Cl. 428/416

(57) ABSTRACT

Provided is a flame retardant adhesive composition including (A) a halogen-free epoxy resin, (B) a thermoplastic resin and/or a synthetic rubber, (C) a curing agent, (D) a curing accelerator, and (E) a phosphorus-containing filler. Also provided are an adhesive sheet, a coverlay film, and a flexible copper-clad laminate prepared using such a composition. A cured product yielded by curing the composition, as well as the adhesive sheet, the coverlay film, and the flexible copper-clad laminate display excellent flame retardancy and electrical characteristics (anti-migration properties).

### BACKGROUND OF THE INVENTION

1. Field of the Invention

The present invention relates to an adhesive composition that is halogen-free, and yields a cured product, on curing, that displays excellent flame retardancy, and also relates to an adhesive sheet, a coverlay film, and a flexible copper-clad laminate that use such a composition.

2. Description of the Prior Art

Conventionally, the adhesives used in electronic materials such as semiconductor sealing materials and glass epoxy-based copper-clad laminates have comprised a bromine-containing epoxy resin or phenoxy resin or the like and thereby display a superior level of flame retardancy. However, because compounds containing halogens such as bromine release toxic gases such as dioxin-based compounds when combusted, in recent years, the use of halogen-free materials in adhesives has been investigated.

On the other hand, flexible copper-clad laminates are being widely used as materials which are thinner than the glass epoxy-based copper-clad laminates mentioned above and offer additional flexibility. Their market size is expanding as various electronic materials become thinner and have higher density. Flexible copper-clad laminates are copper-clad laminates with flexibility, which are produced by bonding a polyimide film and a copper foil through an adhesive by heating, and then heat-curing the adhesive. In a similar manner to the adhesives used in the electronic materials described above, the use of halogen-free materials in the adhesives used in these flexible copper-clad laminates is also being investigated.

Furthermore, once the copper foil of a flexible copper-clad laminate has been processed to form a wiring pattern, an electrically insulating film (a coverlay film) such as a polyimide film with an adhesive is used as a material which covers the surface on which the wiring pattern has been formed, thereby protecting the wiring. Examples of the properties required for the materials for these flexible copper-clad laminates and coverlay films include adhesion between the electrically insulating film and the copper foil, as well as heat resistance, solvent resistance, electrical characteristics (anti-migration properties), dimensional stability, storage stability, and flame retardancy. In addition, when flexible printed wiring boards prepared by crimping a coverlay film are bonded together to form multilayered structures with increased density, the adhesive films (adhesive sheets) used for bonding the boards together require the same characteristics as those required by flexible copper-clad laminates and coverlay films.

Examples of known materials that satisfy the above requirements include adhesive compositions comprising an epoxy resin, an aromatic phosphate ester, a curing agent, and a high-purity acrylonitrile butadiene rubber, as well as flexible copper-clad laminates and coverlays that use such adhesive compositions (see patent reference 1). However, high-purity acrylonitrile butadiene rubber is extremely expensive, meaning that with the exception of certain special applications, large-scale use of this material is difficult. In addition, adhesive compositions comprising an epoxy resin, an aromatic phosphate ester, a nitrogen-containing phenol novolac resin, and a normal purity acrylonitrile butadiene rubber, as well as flexible copper-clad laminates and coverlays that use such adhesive compositions, are also known (see patent reference 2), but because these materials use normal purity acrylonitrile butadiene rubber, the anti-migration properties deteriorate.

[Patent Reference 1]
JP2001-339131A

[Patent Reference 2]
JP2001-339132A

### SUMMARY OF THE INVENTION

An object of the present invention is to provide an adhesive composition that is halogen-free, and yields a cured product, on curing, that displays excellent flame retardancy and electrical characteristics (anti-migration properties), as well as an adhesive sheet, a coverlay film, and a flexible copper-clad laminate that use such a composition.

In order to achieve this object, the present invention provides a flame retardant adhesive composition comprising
(A) a halogen-free epoxy resin,
(B) a thermoplastic resin and/or a synthetic rubber,
(C) a curing agent,
(D) a curing accelerator, and
(E) a phosphorus-containing filler.

A second aspect of the present invention provides an adhesive sheet, comprising a layer comprising the above composition, and a protective layer for covering the layer comprising the composition.

A third aspect of the present invention provides a coverlay film, comprising an electrically insulating film that has undergone low-temperature plasma treatment, and a layer comprising the above composition provided on top of the electrically insulating film.

A fourth aspect of the present invention provides a flexible copper-clad laminate, comprising an electrically insulating film that has undergone low-temperature plasma treatment, a layer comprising the above composition provided on top of the electrically insulating film, and copper foil.

A composition of the present invention is halogen-free, and yields a cured product, on curing, that displays excellent flame retardancy, peel strength, electrical characteristics (anti-migration properties), and solder heat resistance. Accordingly, adhesive sheets, coverlay films, and flexible copper-clad laminates prepared using this composition also display excellent flame retardancy, peel strength, electrical characteristics (anti-migration properties), and solder heat resistance.

### DETAILED DESCRIPTION OF THE PREFERRED EMBODIMENTS

<Flame Retardant Adhesive Composition>

As follows is a detailed description of the various components of a flame retardant adhesive composition of the present invention. In this description, room temperature refers to a temperature of 25° C. Furthermore, glass transition temperatures (Tg) refer to glass transition temperatures measured using the DMA method.

[Halogen-free Epoxy Resin (A)]

A halogen-free epoxy resin of the component (A) is an epoxy resin that contains no halogen atoms such as bromine within the molecular structure, but contains an average of at least 2 epoxy groups within each molecule. There are no particular restrictions on this epoxy resin, which may also incorporate, for example, silicone, urethanes, polyimides or polyamides or the like. Furthermore, the molecular skeleton may also incorporate phosphorus atoms, sulfur atoms, or nitrogen atoms or the like.

Specific examples of this epoxy resin include bisphenol A epoxy resins, bisphenol F epoxy resins, and hydrogenated products thereof; glycidyl ether based epoxy resins such as phenol novolac epoxy resins and cresol novolac epoxy resins; glycidyl ester based epoxy resins such as glycidyl hexahydrophthalate and dimer acid glycidyl ester; glycidyl amine based epoxy resins such as triglycidyl isocyanurate and tetraglycidyldiaminodiphenylmethane; and linear aliphatic epoxy resins such as epoxidated polybutadiene and epoxidated soybean oil, and of these, bisphenol A epoxy resins, bisphenol F epoxy resins, phenol novolac epoxy resins, and cresol novolac epoxy resins are preferred. Examples of commercially available products of these include the brand names Epikote 828 (manufactured by Japan Epoxy Resins Co., Ltd., number of epoxy groups per molecule: 2), Epiclon 830S (manufactured by Dainippon Ink and Chemicals, Incorporated, number of epoxy groups per molecule: 2), Epikote 517 (manufactured by Japan Epoxy Resins Co., Ltd., number of epoxy groups per molecule: 2), and EOCN103S (manufactured by Nippon Kayaku Co., Ltd., number of epoxy groups per molecule: at least 2).

Furthermore, the various phosphorus-containing epoxy resins, which contain bonded phosphorus atoms produced using a reactive phosphorus compound, can also be used effectively in forming a halogen-free flame retardant adhesive composition. Specifically, for example, compounds produced by reacting either 9,10-dihydro-9-oxa-10-phosphaphenanthrene-10-oxide (brand name: HCA, manufactured by Sanko Co., Ltd.) or a compound in which the active hydrogen atom bonded to the phosphorus atom of HCA has been substituted with hydroquinone (brand name: HCA-HQ, manufactured by Sanko Co., Ltd.) with an aforementioned epoxy resin can be used. Examples of commercially available products of these include the brand names FX305 (manufactured by Tohto Kasei Co., Ltd., phosphorus content: 3%, number of epoxy groups per molecule: at least 2), and Epiclon EXA9710 (manufactured by Dainippon Ink and Chemicals, Incorporated, phosphorus content: 3%, number of epoxy groups per molecule: at least 2).

These epoxy resins can be used either singularly, or in combinations of two or more different resins.

[Thermoplastic Resin/Synthetic Rubber (B)]

Thermoplastic Resin

Thermoplastic resins that can be used as the component (B) are polymer compounds with a glass transition temperature (Tg) of room temperature or higher. The weight average molecular weight of the resin is typically within a range from 1,000 to 5,000,000, and preferably from 5,000 to 1,000,000. There are no particular restrictions on the type of thermoplastic resin used, and suitable examples thereof include polyester resins, acrylic resins, phenoxy resins, polyamideimide resins, and epoxy resins with a weight average molecular weight of 1,000 or greater. Of these, those resins that incorporate a carboxyl group are preferred. If the resin incorporates a carboxyl group, then in those cases where the product composition is used within a coverlay film, the adhesive exhibits a favorable level of fluidity (flow characteristics) during the heat press treatment used to form an integrated laminate. This fluidity of the adhesive enables the adhesive to cover and protect the copper foil portion (the wiring pattern) that forms the circuit on the surface of the flexible copper-clad laminate with no gaps. Furthermore, such fluidity is also effective in improving the adhesion between the copper foil and the electrically insulating film such as a polyimide film.

There are no particular restrictions on the carboxyl group content within the type of carboxyl group-containing thermoplastic resin described above, although the quantity of the monomeric unit that contains the carboxyl group preferably accounts for 1 to 10 mol %, and even more preferably from 2 to 6 mol % of the resin. If this content falls within a range from 1 to 10 mol %, then the flow characteristics and the solder resistance are more superior when the product composition is used within a coverlay film, and the stability of the adhesive varnish is also superior.

Examples of commercially available carboxyl group-containing thermoplastic resins, listed in terms of their brand names, include the “Vylon” series (carboxyl group-containing polyester resins, manufactured by Toyobo Co., Ltd.), 03-72-23 (a carboxyl group-containing acrylic resin, manufactured by Kyodo Chemical Co., Ltd.), and the “KS” series (epoxy group-containing acrylic resins, manufactured by Hitachi Chemical Co., Ltd.).

Examples of other commercially available thermoplastic resins, listed in terms of their brand names, include the “YP” series and “ERF” series (phenoxy resins, manufactured by Tohto Kasei Co., Ltd.), Epikote 1256 (a phenoxy resin, manufactured by Japan Epoxy Resins Co., Ltd.), the “Vylomax” series (polyamideimide resins, manufactured by Toyobo Co., Ltd.), and the “Kayaflex” series (polyamideimide resins, manufactured by Nippon Kayaku Co., Ltd.

Next is a description of the characteristics of each of the thermoplastic resins listed above. If a composition comprising an acrylic resin is used in a coverlay film, then a product with particularly superior anti-migration characteristics can be obtained. If a composition comprising either a phenoxy resin or a polyamideimide resin is used in a coverlay film, then the flexibility can be further improved. A composition comprising an epoxy resin with a weight average molecular weight of 1,000 or greater is particularly useful in imparting an appropriate level of adhesion and flexibility to an adhesive sheet, a coverlay film, or a flexible copper-clad laminate.

Synthetic Rubber

Synthetic rubbers that can be used as an alternative component (B) are polymer compounds with a glass transition temperature (Tg) that is less than room temperature. There are no particular restrictions on the synthetic rubber, although in those cases where the rubber is blended into a composition that is used in a flexible copper-clad laminate or a coverlay film, then from the viewpoint of improving the adhesion between the copper foil and the electrically insulating film such as a polyimide film or the like, carboxyl group-containing acrylonitrile-butadiene rubbers (hereafter, the term “acrylonitrile-butadiene rubber” may also be abbreviated as “NBR”) are particularly preferred.

Examples of these carboxyl group-containing NBR include copolymer rubbers produced by the copolymerization of acrylonitrile and butadiene so that the ratio of the quantity of acrylonitrile relative to the combined quantity of the acrylonitrile and the butadiene is preferably within a range from 5 to 70% by mass, and particularly preferably from 10 to 50% by mass, in which the molecular chain terminals have been carboxylated, as well as copolymer rubbers of acrylonitrile, butadiene, and a carboxyl group-containing monomer such as acrylic acid or maleic acid. The above carboxylation can be conducted using, for example, monomers that contain a carboxyl group, such as methacrylic acid or the like.

There are no particular restrictions on the carboxyl group content within the aforementioned carboxyl group-containing NBR (namely, the ratio of the aforementioned monomeric unit containing the carboxyl group relative to the total quantity of monomers used for forming the carboxyl group-containing NBR), although preferred content values are within a range from 1 to 10 mol %, and particularly preferably from 2 to 6 mol %. If this content falls within this range from 1 to 10 mol %, then the fluidity of the product composition can be controlled, meaning a favorable level of curability can be achieved.

Specific examples of these carboxyl group-containing NBR include the brand name Nipol 1072 (manufactured by Zeon Corporation), and the high-purity, low ionic impurity product PNR-1H (manufactured by JSR Corporation). High-purity carboxyl group-containing acrylonitrile butadiene rubbers are expensive and can therefore not be used in large quantities, although they are effective in improving both the adhesion and the anti-migration properties simultaneously.

In addition, in those cases where an adhesive composition of the present invention is applied to a coverlay film, joint use of a hydrogenated NBR is effective. In these synthetic rubbers, the butadiene double bonds within the aforementioned NBR rubbers have been converted to single bonds through hydrogenation, and consequently deterioration of the butadiene rubber component through heat history does not occur. Accordingly, neither deterioration of the peel strength between the adhesive composition and the copper foil as a result of heat history, nor deterioration of the anti-migration characteristics as a result of heating occur. By combining the carboxyl group-containing NBR and a hydrogenated NBR, a coverlay film and a flexible copper-clad laminate with better balance between the various characteristics can be obtained. Specific examples of commercially available products include the Zetpol series (manufactured by Zeon Corporation).

The thermoplastic resins and synthetic rubbers described above can each be used either singularly, or in combinations of two or more different materials. Furthermore, the component (B) may comprise either one of thermoplastic resins or synthetic rubbers, or may comprise both types of material.

There are no particular restrictions on the blend quantity (if both a thermoplastic resin and a synthetic rubber are used, then the combined quantity) of the component (B), although the quantity is typically within a range from 10 to 2,500 parts by mass, and preferably from 20 to 300 parts by mass, per 100 parts by mass of the component (A). If the quantity of the component (B) falls within this range from 10 to 2,500 parts by mass, then the product flexible copper-clad laminate, coverlay, or adhesive sheet displays superior flame retardancy, and superior peel strength from the copper foil.

[Curing Agent (C)]

There are no particular restrictions on the curing agent of the component (C), and any of the materials typically used as epoxy resin curing agents can be used. Examples of the curing agent include polyamine-based curing agents, acid anhydride-based curing agents, boron trifluoride amine complex salts, and phenol resins. Specific examples of polyamine-based curing agents include aliphatic amine-based curing agents such as diethylenetriamine, tetraethylenetetramine, and tetraethylenepentamine; alicyclic amine-based curing agents such as isophorone diamine; aromatic amine-based curing agents such as diaminodiphenylmethane and phenylenediamine; and dicyandiamide. Specific examples of acid anhydride-based curing agents include phthalic anhydride, pyromellitic anhydride, trimellitic anhydride, and hexahydrophthalic anhydride. Of these, when the product composition is used in a coverlay film, polyamine-based curing agents are preferred because a suitable level of reactivity is required, whereas when the product composition is used in a flexible copper-clad laminate, acid anhydride-based curing agents are preferred because they can impart a superior level of heat resistance.

The above curing agents can be used either singularly, or in combinations of two or more different compounds.

There are no particular restrictions on the blend quantity of the component (C), although the quantity is typically within a range from 0.5 to 100 parts by mass, and preferably from 1 to 20 parts by mass, per 100 parts by mass of the component (A).

[Curing Accelerator (D)]

There are no particular restrictions on the curing accelerator of the component (D), provided it accelerates the reaction between the halogen-free epoxy resin (A) and the curing agent (C). Specific examples of this curing accelerator include imidazole compounds such as 2-methylimidazole, 2-ethylimidazole, 2-ethyl-4-methylimidazole, ethyl isocyanate compounds of these compounds, 2-phenylimidazole, 2-phenyl-4-methylimidazole, 2-phenyl-4-methyl-5-hydroxymethylimidazole, and 2-phenyl-4,5-dihydroxymethylimidazole; triorganophosphine compounds such as triphenylphosphine, tributylphosphine, tris(p-methylphenyl)phosphine, tris(p-methoxyphenyl)phosphine, tris(p-ethoxyphenyl)phosphine, triphenylphosphine-triphenylborate, and tetraphenylphosphine-tetraphenylborate; quaternary phosphonium salts; tertiary amines such as triethyleneammonium triphenylborate, and the tetraphenylborates thereof; and fluoroborates such as zinc fluoroborate, tin fluoroborate, and nickel fluoroborate; and octylate salts such as tin octylate and zinc octylate.

These curing accelerators can be used either singularly, or in combinations of two or more different compounds.

There are no particular restrictions on the blend quantity of the component (D), although the quantity is typically within a range from 0.1 to 30 parts by mass, and preferably from 1 to 20 parts by mass, and particularly preferably from 1 to 5 parts by mass, per 100 parts by mass of the component (A).

[Phosphorus-containing Filler (E)]

The phosphorus-containing filler of the component (E) is a halogen-free component that imparts flame retardancy. There are no particular restrictions on this phosphorus-containing filler, and suitable examples include phosphate ester amide compounds, and nitrogen-containing phosphate compounds. There are no particular restrictions on the phosphate ester amide compounds, although from the viewpoint of having a favorable heat resistance for the cured product, aromatic phosphate ester amides are preferred. Similarly, there are no particular restrictions on the nitrogen-containing phosphate compounds, although from the viewpoint of achieving superior flame retardancy for the cured product, the phosphorus content is preferably at least 10% by mass, and is more preferably within a range from 10 to 30% by mass.

The phosphorus-containing fillers described above are insoluble in the types of organic solvents such as methyl ethyl ketone (hereafter abbreviated as “MEK”), toluene, and dimethylacetamide typically used as the adhesive varnish, and consequently offer the advantage that when used in a coverlay film, they are very unlikely to bleed out during heat pressing and curing of the coverlay film. Examples of commercially available phosphorus-containing fillers include the brand names SP-703 (an aromatic phosphate ester amide-based filler, manufactured by Shikoku Corporation) and NH-12B (a nitrogen-containing phosphate-based filler, manufactured by Ajinomoto Fine-Techno Co., Inc., phosphorus content: 19% by mass).

These phosphorus-containing fillers can be used either singularly, or in combinations of two or more different compounds.

There are no particular restrictions on the blend quantity of the component (E), although from the viewpoint of ensuring favorable flame retardancy, the quantity is preferably within a range from 5 to 50 parts by mass, and more preferably from 7 to 30 parts by mass, per 100 parts by mass of the combination of the organic resin components and the inorganic solid components within the adhesive composition. As described below, the term “organic resin components” specifically refers mainly to the components (A) through (E), and any optional components that are added. Furthermore, as described below, the term “inorganic solid components” specifically refers to inorganic fillers that may optionally be added to the composition, and other components that may optionally be added. In the case where the organic resin components and the inorganic solid components within the adhesive composition are the components (A) through (E) and inorganic fillers, the quantity of the component (E) is preferably within a range from 5 to 50 parts by mass, and more preferably from 7 to 30 parts by mass, per 100 parts by mass of the combined quantity of the components (A) through (E), and an inorganic filler that may optionally be added to the composition.

[Other Optional Components]

In addition to the components (A) through (E) described above, other optional components may also be added.

Inorganic Fillers

Inorganic fillers can be added to the composition, in addition to the phosphorus-containing filler of the component (E). There are no particular restrictions on these inorganic fillers, and any fillers used in conventional adhesive sheets, coverlay films, and flexible copper-clad laminates can be used. Specifically, from the viewpoint of also functioning as flame retardancy assistants, for example, metal oxides such as aluminum hydroxide, magnesium hydroxide, silicon dioxide, and molybdenum oxide can be used, and of these, aluminum hydroxide and magnesium hydroxide are preferred. These inorganic fillers can be used either singularly, or in combinations of two or more different compounds.

There are no particular restrictions on the blend quantity of the above inorganic fillers, although the quantity is preferably within a range from 5 to 60 parts by mass, and more preferably from 7 to 30 parts by mass, per 100 parts by mass of the combination of the organic resin components and the inorganic solid components within the adhesive composition.

Organic Solvents

The components (A) to (E), and any optional components that have been added as required, may be used in a solventless state in the production of a flexible copper-clad laminate, a coverlay film, and an adhesive sheet, although production may also be conducted with the components dissolved or dispersed in an organic solvent to form a solution or a dispersion (hereafter, referred to as simply a “solution”) of the composition. Examples of suitable organic solvents include N,N-dimethylacetamide, methyl ethyl ketone, N,N-dimethylformamide, cyclohexanone, N-methyl-2-pyrrolidone, toluene, methanol, ethanol, isopropanol, and acetone, and of these, N,N-dimethylacetamide, methyl ethyl ketone, N,N-dimethylformamide, cyclohexanone, and N-methyl-2-pyrrolidone are preferred, and N,N-dimethylacetamide and methyl ethyl ketone are particularly preferred. These organic solvents can be used either singularly, or in combinations of two or more different solvents.

The combined concentration of the organic resin components and the inorganic solid components within such an adhesive solution is typically within a range from 10 to 45% by mass, and preferably from 20 to 40% by mass. If this concentration falls within this range from 10 to 45% by mass, then the adhesive solution displays a favorable level of ease of application to substrates such as electrically insulating films, thus providing superior workability, and also offers superior coatability, with no irregularities during coating, while also providing superior performance in terms of environmental and economic factors.

The term “organic resin components” describes the non-volatile organic components that constitute the cured product obtained on curing of the adhesive composition of the present invention, and specifically, refers mainly to the components (A) through (E), and any optional components that are added. In those cases where the adhesive composition comprises an organic solvent, the organic solvent is usually not included within the organic resin components. Furthermore, the term “inorganic solid components” refers to the non-volatile inorganic solid components contained within the adhesive composition of the present invention, and specifically, refers to inorganic fillers that may optionally be added to the composition, and other components that may optionally be added.

The organic resin components of the composition of the present invention, together with any added inorganic solid components and organic solvents can be mixed together using a pot mill, ball mill, homogenizer, or super mill or the like.

<Coverlay Films>

The composition described above can be used in the production of coverlay films. Specifically, for example, coverlay films comprising an electrically insulating film that has undergone low-temperature plasma treatment, and a layer comprising the above composition formed on top of the electrically insulating film can be produced. As follows is a description of a process for producing such a coverlay film.

An adhesive solution, comprising a composition of the present invention prepared in a liquid form by mixing the required components with an organic solvent beforehand, is applied, using a reverse roll coater or a comma coater or the like, to an electrically insulating film that has undergone low-temperature plasma treatment. The electrically insulating film with the applied film of adhesive solution is then passed through an in-line dryer, and heated at 80 to 160° C. for a period of 2 to 10 minutes, thereby removing the organic solvent, and drying the composition to form a semi-cured state. A roll laminator is then used to crimp and laminate the coated film to a protective layer, thereby forming a coverlay film. The protective layer is peeled off at the time of use. The term “semi-cured state” refers to a state where the composition is dry, and a state where the curing reaction is proceeding within portions of the composition.

The dried thickness of the coating film of the composition in the above coverlay film is typically within a range from 5 to 45 μm, and preferably from 5 to 35 μm.

Electrically Insulating Film

The above electrically insulating film is used in flexible copper-clad laminates and coverlay films of the present invention. There are no particular restrictions on the electrically insulating film, and any film that is typically used in flexible copper-clad laminates and coverlay films, and has undergone low temperature plasma treatment can be used. Specific examples of suitable films include low temperature plasma treated polyimide films, polyethylene terephthalate films, polyester films, polyparabanic acid films, polyetheretherketone films, polyphenylene sulfide films, and aramid films; as well as films produced using glass fiber, aramid fiber, or polyester fiber as a base, wherein this base is impregnated with a matrix such as an epoxy resin, polyester resin, or diallyl phthalate resin, and the impregnated base is then formed into a film or sheet form, which is subsequently bonded to a copper foil. From the viewpoints of achieving favorable heat resistance, dimensional stability, and mechanical characteristics for the produced coverlay film, low temperature plasma treated polyimide films are particularly preferred. Any of the polyimide films typically used in coverlay films can be used. The thickness of this electrically insulating film can be set to any desired value, depending on need, although thickness values from 12.5 to 50 μm are preferred.

In a preferred embodiment of the present invention, the electrically insulating film that has undergone low-temperature plasma treatment is prepared by treating the surface of an electrically insulating film with an inorganic gas low temperature plasma generated by a direct current voltage or alternating current voltage of 0.1 to 10 kV in an atmosphere of an inorganic gas under the pressure within a range from 0.133 to 1,333 Pa, and preferably from 1.33 to 133 Pa. Specifically, a low temperature plasma treated polyimide film is used. The treatment process for this film is described below. More specifically, the polyimide film is placed inside a low temperature plasma treatment apparatus that is capable of reduced pressure operation, the atmosphere inside the apparatus is replaced with an inorganic gas, and with the pressure held within a range from 0.133 to 1,333 Pa, and preferably from 1.33 to 133 Pa, a direct current voltage or alternating current voltage of 0.1 to 10 kV is applied across the electrodes, causing a glow discharge and thereby generating an inorganic gas low temperature plasma. The film is then moved, while the film surface is subjected to continuous treatment. The treatment time is typically within a range from 0.1 to 100 seconds. Examples of the inorganic gas include inert gases such as helium, neon, and argon, as well as oxygen, carbon monoxide, carbon dioxide, ammonia, and air. These inorganic gases can be used either singularly, or in combinations of two or more different gases.

This low temperature plasma treatment improves the adhesion between the polyimide film and the adhesive layer formed on top of the film. In those cases where a thermoplastic resin is used as the component (B) in the composition of the present invention, because the glass transition temperature (Tg) of such compounds is typically high, the adhesion between a polyimide film and the composition of the present invention can sometimes be unsatisfactory. In such cases, the combined use of a low temperature plasma treated film can improve the adhesion. Furthermore, even in those cases where a synthetic rubber is used as the component (B), low temperature plasma treatment is still advantageous as it further improves the adhesion.

Protective Layer

There are no particular restrictions on the protective layer described above, provided it is able to be peeled off without damaging the form of the adhesive layer, and typical examples of suitable films include plastic films such as polyethylene (PE) films, polypropylene (PP) films, polymethylpentene (TPX) films, and polyester films; and release papers in which a polyolefin film such as a PE film or PP film, or a TPX film is coated onto one side or both sides of a paper material.

<Adhesive Sheets>

The composition described above can be used in the production of adhesive sheets. Specifically, for example, adhesive sheets comprising a layer comprising the composition, and a protective layer for covering the layer comprising the composition can be produced. As follows is a description of a process for producing such an adhesive sheet of the present invention.

An adhesive solution, comprising a composition of the present invention prepared in a liquid form by mixing the required components with an organic solvent beforehand, is applied to a protective layer using a reverse roll coater or a comma coater or the like. The protective layer with the applied adhesive solution film is then passed through an in-line dryer, and heated at 80 to 160° C. for a period of 2 to 10 minutes, thereby removing the organic solvent, and drying the composition to form a semi-cured state. A roll laminator is then used to crimp and laminate the coated layer to another protective layer, thereby forming an adhesive sheet.

<Flexible Copper-Clad Laminates>

The composition described above can be used in the production of flexible copper-clad laminates. Specifically, for example, flexible copper-clad laminates comprising an electrically insulating film, a layer comprising the above composition formed on top of the film, and copper foil can be produced. The electrically insulating film can use the same type of electrically insulating film described in relation to the aforementioned coverlay films. As follows is a description of a process for producing a flexible copper-clad laminate.

An adhesive solution, comprising a composition of the present invention prepared in a liquid form by mixing the required components with an organic solvent beforehand, is applied, using a reverse roll coater or a comma coater or the like, to an electrically insulating film that has undergone low-temperature plasma treatment. The electrically insulating film with the applied adhesive solution film is then passed through an in-line dryer, and heated at 80 to 160° C. for a period of 2 to 10 minutes, thereby removing the organic solvent, and drying the composition to form a semi-cured state. This structure is then heat laminated (using thermocompression bonding) to a copper foil at 100 to 150° C., thereby forming a flexible copper-clad laminate. By subjecting this flexible copper-clad laminate to after-curing, the semi-cured composition is completely cured, yielding the final flexible copper-clad laminate.

The dried thickness of the coating film of the composition in the above flexible copper-clad laminate is typically within a range from 5 to 45 μm, and preferably from 5 to 18 μm.

The copper foil described above can use the rolled, electrolytic copper foil product typically used in conventional flexible copper-clad laminates. The thickness of the copper foil is typically within a range from 5 to 70 μm.

### EXAMPLES

As follows is a more detailed description of the present invention using a series of examples. However, the present invention is in no way limited by the examples presented below. Specifically, the components (A) through (E), and the other optional components used in the examples are as described below. The units for the numbers representing the blend proportions in the tables are “parts by mass”.

<Adhesive Composition Components>

Halogen-Free Epoxy Resins (A)
(1) Epikote 604 (brand name) (manufactured by Japan Epoxy Resins Co., Ltd., number of epoxy groups per molecule: 4)
(2) Epikote 517 (brand name) (manufactured by Japan Epoxy Resins Co., Ltd., number of epoxy groups per molecule: 2)
(3) Epikote 828 (brand name) (manufactured by Japan Epoxy Resins Co., Ltd., number of epoxy groups per molecule: 2)
(4) Epikote 1001 (brand name) (manufactured by Japan Epoxy Resins Co., Ltd., number of epoxy groups per molecule: 2)
(5) EOCN103S (brand name) (manufactured by Nippon Kayaku Co., Ltd., number of epoxy groups per molecule: at least 2)
(6) EP4022 (brand name) (manufactured by Asahi Denka Co., Ltd., number of epoxy groups per molecule: at least 2)
(7) EP-49-20 (brand name) (manufactured by Asahi Denka Co., Ltd., number of epoxy groups per molecule: at least 2)
(8) EPU-78-11 (brand name) (manufactured by Asahi Denka Co., Ltd., number of epoxy groups per molecule: at least 2)
(9) Epiclon 830S (brand name) (manufactured by Dainippon Ink and Chemicals, Incorporated, number of epoxy groups per molecule: 2)

Thermoplastic Resins (B-1)
(1) Vylon 237 (brand name) (a phosphorus-containing polyester resin, manufactured by Toyobo Co., Ltd.)
(2) 03-72-23 (brand name) (a carboxyl group-containing acrylic resin, manufactured by Kyodo Chemical Co., Ltd.)
(3) ERF-001-4 (brand name) (a phosphorus-containing phenoxy resin, manufactured by Tohto Kasei Co., Ltd.)
(4) Vylomax HR12N2 (brand name) (a polyamideimide resin, manufactured by Toyobo Co., Ltd.)
(5) KS8006 (brand name) (an epoxy group-containing acrylic resin, manufactured by Hitachi Chemical Co., Ltd.)

Synthetic Rubbers (B-2)
(1) Vylon 30P (brand name) (a polyester rubber, manufactured by Toyobo Co., Ltd.)
(2) PNR-1H (brand name) (a carboxyl group-containing NBR high-purity product, manufactured by JSR Corporation)
(3) Nipol 1072 (brand name) (a carboxyl group-containing NBR, manufactured by Zeon Corporation)

Curing Agents (C)
(1) EH705A (brand name) (an acid anhydride-based curing agent, manufactured by Asahi Denka Co., Ltd.)
(2) DDS (diamine-based curing agent)
(3) Phenolite J-325 (brand name) (a phenol resin, manufactured by Dainippon Ink and Chemicals, Incorporated)
(4) KC-01 (brand name) (an amine-based curing agent, manufactured by Konishi Co., Ltd.)

Curing Accelerators (D)
(1) 2E4MZ-CN (brand name) (an imidazole-based curing accelerator, manufactured by Shikoku Corporation)
(2) 2E4MZ (brand name) (an imidazole-based curing accelerator, manufactured by Shikoku Corporation)

Phosphorus-Containing Fillers (E)
(1) Polysafe NH-12B (brand name) (a nitrogen-containing phosphate-based filler, manufactured by Ajinomoto Fine-Techno Co., Inc., phosphorus content: 19% by mass)
(2) SP-703 (brand name) (an aromatic phosphate ester amide-based filler, manufactured by Shikoku Corporation)

(Optional) Inorganic Fillers
(1) Higilite H43STE (aluminum hydroxide, manufactured by Showa Denko K.K.)
(2) Zinc white (zinc oxide)

(Other) Phosphorus-Containing Compounds
(1) SPE-100 (brand name) (a phosphazene-based filler, soluble in organic solvents such as MEK, manufactured by Otsuka Chemical Co., Ltd.)
   <Characteristics of Flexible Copper-Clad Laminates>

### Example 1

Each of the components of the adhesive composition were combined in the ratios shown in the column labeled Example 1 in Table 1, and a mixed solvent of methyl ethyl ketone and toluene was then added to the resulting mixture, yielding an adhesive solution in which the combined concentration of the organic resin components and the inorganic solid components was 35% by mass.

Meanwhile, one side of a polyimide film A (brand name: Kapton V, manufactured by DuPont Corporation, thickness: 25 μm) was subjected to low temperature plasma treatment under predetermined conditions (pressure: 13.3 Pa, argon flow rate: 1.0 L/minute, applied voltage 2 kV, frequency: 110 kHz, power: 30 kW, treatment speed: 10 m/minute). Subsequently, an applicator was used to apply the adhesive solution described above to the treated surface of the polyimide film, in sufficient quantity to generate a dried coating of thickness 18 μm, and the applied coating was then dried for 10 minutes at 140° C. in a forced air oven, thereby converting the composition to a semi-cured state. The semi-cured composition and the treated surface of a rolled copper foil (manufactured by Japan Energy Corporation, thickness: 35 μm) were then joined by thermocompression bonding at 140° C., and subsequent after-curing for 2 hours at 80° C., 3 hours at 120° C., and a further 5 hours at 160° C. was used to complete the preparation of a flexible copper-clad laminate. The characteristics of this flexible copper-clad laminate were measured in accordance with the measurement methods 1 described below. The results are shown in Table 1.

### Example 2

With the exceptions of combining each of the components of the adhesive composition in the ratios shown in the column labeled Example 2 in Table 1, and replacing the polyimide film A with a polyimide film B (brand name: Apical NPI, manufactured by Kanegafuchi Chemical Industry Co., Ltd., thickness: 25 μm), a flexible copper-clad laminate was prepared in the same manner as Example 1. The characteristics of this flexible copper-clad laminate were also measured in accordance with the measurement methods 1 described below. The results are shown in Table 1.

### Comparative Examples 1 and 2

With the exceptions of combining each of the components of the adhesive composition in the ratios shown in the columns labeled Comparative Examples 1 and 2 respectively in Table 1, and using a polyimide film A that had not undergone plasma treatment, flexible copper-clad laminates were prepared in the same manner as Example 1. The characteristics of these flexible copper-clad laminate were also measured in accordance with the measurement methods 1 described below. The results are shown in Table 1.

[Measurement Methods 1]

1-1. Peel Strength

The peel strength was measured in accordance with JIS C6481, by forming a circuit with a pattern width of 1 mm on the flexible copper-clad laminate, and then peeling the copper foil (the aforementioned circuit) at an angle of 90 degrees and a speed of 50 mm/minute under conditions at 25° C.

1-2. Solder Heat Resistance (Normal Conditions)

The solder heat resistance was measured in accordance with JIS C6481, by preparing a test specimen by cutting a 25 mm square from the flexible copper-clad laminate, floating this test specimen on a solder bath for 30 seconds, and then measuring the maximum temperature for which no blistering, peeling, or discoloration occurs on the test specimen.

1-3. Flame Retardancy

A sample was first prepared by removing the entire copper film from the flexible copper-clad laminate using an etching treatment. The flame retardancy of this sample was then measured in accordance with the flame retardancy standard UL94VTM-0. If the sample satisfied the flame retardancy requirements of UL94VTM-0 it was evaluated as “good”, and was recorded using the symbol O, whereas if the sample combusted, it was evaluated as “poor”, and was recorded using the symbol x.

TABLE 1

| | | | | Example | Example | Comparative | Comparative |
|---|---|---|---|---|---|---|---|
| | | | | 1 | 2 | Example 1 | Example 2 |
| <Components> | | | (Brand name) | | | | |
| A | Halogen-free | | Epikote 517 | 30 | 30 | 30 | 80 |
| | epoxy resin | | Epikote 604 | 50 | 60 | 50 | |
| | | | Epikote 828 | 20 | | 20 | 10 |
| | | | EP4022 | | 10 | | 10 |
| B | (1) | Thermoplastic resin | Vylon 237 | | 150 | | 150 |
| | (2) | Synthetic rubber | Vylon 30P | 150 | | 150 | |

| | | | | | | |
|---|---|---|---|---|---|---|
| C | Curing agent | EH705A | 10 | 10 | 10 | 10 |
| | | KC-01 | 3 | 3 | 3 | 3 |
| D | Curing accelerator | 2E4MZ-CN | 6 | 6 | 6 | 10 |
| E | Phosphorus-containing | Polysafe NH-12B | 50 | | | |
| | filler | SP-703 | | 60 | | |
| optional | Inorganic filler | Higilite H43STE | 30 | 30 | 30 | 30 |
| other | Phosphorus-containing | SPE-100 | | | 100 | |
| | compound | | | | | |

| <Characteristics> | (Units) | | | | |
|---|---|---|---|---|---|
| Peel strength | N/cm | 1.2 | 1.1 | 0.5 | 0.8 |
| Solder heat resistance (normal | ° C. | ≧330 | ≧330 | ≦300 | ≧330 |
| conditions) | | | | | |
| Flame retardancy | VTM-0 | O | O | O | x |

<Characteristics of Coverlay Films>

### Examples 3 to 6

With the exception of combining each of the components of the adhesive composition in the ratios shown in the columns labeled Examples 3 through 6 in Table 2, adhesive solutions were prepared in the same manner as Example 1. Meanwhile, polyimide films B were subjected to low temperature plasma treatment under the same conditions as those described for Example 1. Subsequently, an applicator was used to apply each adhesive solution described above to a treated surface of a polyimide film, in sufficient quantity to generate a dried coating of thickness 25 μm, and the applied coating was then dried for 10 minutes at 140° C. in a forced air oven, thereby converting the composition to a semi-cured state, and forming a coverlay film. The characteristics of each of these coverlay films were then measured in accordance with the measurement methods 2 described below. The results are shown in Table 2.

### Comparative Examples 3 and 4

With the exceptions of combining each of the components of the adhesive composition in the ratios shown in the columns labeled Comparative Examples 3 and 4 respectively in Table 2, and using a polyimide film B that had not undergone plasma treatment, coverlay films were prepared in the same manner as Example 3. The characteristics of these coverlay films were also measured in accordance with the measurement methods 2 described below. The results are shown in Table 2.

[Measurement Methods 2]

2-1. Peel Strength

The peel strength was measured in accordance with JIS C6481, by first preparing a pressed sample by bonding the adhesive layer of the coverlay film to the glossy surface of an electrolytic copper foil of thickness 35 μm (manufactured by Japan Energy Corporation) using a press device (temperature: 160° C., pressure: 50 kg/cm², time: 40 minutes). In the case of the coverlay film produced in Example 6, the press temperature was increased to 180° C. This pressed sample was then cut to form a test specimen with dimensions of width 1 cm, length 15 cm, and thickness 72 μm, the polyimide film surface of this test specimen was secured, and the copper foil was then peeled at an angle of 90 degrees and a speed of 50 mm/minute under conditions at 25° C. to measure the peel strength.

2-2. Solder Heat Resistance (Normal Conditions, Moisture Absorption)

With the exception of preparing the test specimen by cutting a 25 mm square from the pressed sample of the coverlay film prepared for the aforementioned peel strength measurement, the solder heat resistance (normal conditions) was measured in the same manner as that described in the above measurement methods 1-2.

In addition, the solder heat resistance (moisture absorption) was also measured by preparing a similar test specimen to that prepared for the measurement of the above solvent heat resistance (normal conditions), subsequently leaving the test specimen to stand for 24 hours in an atmosphere at a temperature of 40° C. and a humidity of 90%, and then floating this test specimen on a solder bath for 30 seconds, and measuring the maximum temperature for which no blistering, peeling, or discoloration occurs on the test specimen.

2-3. Flame Retardancy

Using a press device (temperature: 160° C., pressure: 50 kg/cm², time: 30 minutes), pressed samples were first prepared by bonding each of the coverlay films obtained in Examples 3 to 6 to the adhesive layer of a sample produced by removing the entire copper film from a flexible copper-clad laminate of Example 2 using an etching treatment. Furthermore, using a similar method, pressed samples were also prepared by bonding each of the coverlay films obtained in Comparative Examples 3 and 4 to a sample produced by removing the entire copper film from a flexible copper-clad laminate of Comparative Example 2 using an etching treatment. These pressed samples were evaluated for flame retardancy (as a combination with the flexible copper-clad laminate) in the same manner as that described in the above measurement method 1-3.

2-4. Anti-Migration Characteristics

Using a press device (temperature: 160° C., pressure: 50 kg/cm², time: 40 minutes), pressed samples were prepared by bonding each of the coverlay films obtained in Examples 3 to 6 to a substrate comprising a flexible copper-clad laminate of Example 2 with a circuit of pitch 70 μm printed thereon. Furthermore, using a similar method, pressed samples were also prepared by bonding each of the coverlay films obtained in Comparative Examples 3 and 4 to a substrate comprising a flexible copper-clad laminate of Comparative Example 2 with a circuit of pitch 70 μm printed thereon. Under conditions including a temperature of 85° C. and a humidity of 85%, a voltage of 50 V was applied to the circuit on each of these pressed samples, and after 1000 hours, those samples in which short circuiting had occurred between conductors, or in which dendrite growth was visible were evaluated as “poor”, and were recorded using the symbol x, whereas those samples for which neither problem existed were evaluated as “good”, and were recorded using the symbol O.

TABLE 2

| | | | | | | | | Comparative | Comparative |
|---|---|---|---|---|---|---|---|---|---|
| | | | | Example 3 | Example 4 | Example 5 | Example 6 | Example 3 | Example 4 |
| <Components> | | | (Brand name) | | | | | | |
| A | Halogen-free | | Epikote 828 | 25 | 10 | | | 10 | 25 |
| | epoxy resin | | EOCN103S | 50 | 20 | 50 | | 20 | 50 |
| | | | EP-49-20 | 25 | 20 | | | 20 | |
| | | | Epiclon 830S | | | 25 | 25 | | |
| | | | Epikote 1001 | | | | 25 | | |
| | | | Epikote 517 | | | 25 | 50 | | 25 |
| | | | EPU-78-11 | | 50 | | | 50 | |
| B | (1) | Thermoplastic | 03-72-23 | | 65 | | | | |
| | | resin | ERF-001-4 | | | 20 | | | |
| | | | Vylomax HR12N2 | | | | 50 | | |
| | | | KS8006 | | | | | 65 | |
| | | | Vylon 237 | | | | | | 150 |
| | (2) | Synthetic rubber | PNR-1H | 40 | 10 | 10 | 10 | 10 | |

| | | | | | | | | |
|---|---|---|---|---|---|---|---|---|
| C | Curing agent | DDS | 10 | 10 | 15 | 10 | 10 | |
| | | EH705A | | | | | | 15 |
| D | Curing accelerator | 2E4MZ | 1 | 1 | 1 | 1 | 1 | 1 |
| E | Phosphorus- | Polysafe NH-12B | 15 | | | | | |
| | containing filler | SP-703 | | 25 | 20 | 25 | | |
| optional | Inorganic filler | Higilite H43STE | 35 | 35 | 30 | 30 | 35 | 40 |
| | | Zinc oxide | 1 | 1 | 1 | 1 | 1 | |
| other | Phosphorus- | SPE-100 | | | | | 25 | |
| | containing compound | | | | | | | |

| <Characteristics> | (Units) | | | | | | |
|---|---|---|---|---|---|---|---|
| Peel strength | N/cm | 1.4 | 1.0 | 1.2 | 1.0 | 0.5 | 0.7 |
| Solder heat resistance | ° C. | ≧330 | ≧330 | ≧330 | ≧330 | 280 | 280 |
| (normal conditions) | | | | | | | |
| Solder heat resistance | ° C. | 300 | 300 | 300 | 300 | ≦260 | ≦260 |
| (moisture absorption) | | | | | | | |
| Flame retardancy | VTM-0 | O | O | O | O | O | O |
| Anti-migration characteristics | | O | O | O | O | O | x |

<Characteristics of Adhesive Sheets>

### Example 7

With the exception of combining each of the components of the adhesive composition in the ratios shown in the column labeled Example 7 in Table 3, an adhesive solution was prepared in the same manner as Example 1. Subsequently, an applicator was used to apply the adhesive solution described above to the surface of a polyester film, in sufficient quantity to generate a dried coating of thickness 25 μm, and the applied coating was then dried for 10 minutes at 140° C. in a forced air oven, thereby converting the composition to a semi-cured state, and forming an adhesive sheet. The characteristics of this adhesive sheet were then measured in accordance with the measurement methods 3 described below. The results are shown in Table 3.

### Comparative Example 5

With the exception of combining each of the components of the adhesive composition in the ratios shown in the column labeled Comparative Example 5 in Table 3, an adhesive sheet was prepared in the same manner as Example 7. The characteristics of this adhesive sheet were also measured in accordance with the measurement methods 3 described below. The results are shown in Table 3.

[Measurement Methods 3]

3-1. Peel Strength

With the exception of preparing the pressed sample by removing the protective layers from the adhesive sheet, and then using a press device (temperature: 160° C., pressure: 50 kg/cm², time: 20 minutes) to bond an aforementioned polyimide film B to the glossy surface of an electrolytic copper foil (manufactured by Japan Energy Corporation, thickness: 35 μm) with the adhesive sheet disposed therebetween, the peel strength was measured in the same manner as that described in the above measurement method 2-1.

3-2. Solder Heat Resistance (Normal Conditions, Moisture Absorption)

With the exception of preparing the test specimen by cutting a 25 mm square from the adhesive sheet pressed sample prepared for the above peel strength measurement, the solder heat resistance (under both normal conditions and moisture absorption) was measured in the same manner as that described in the above measurement method 2-2.

3-3. Flame Retardancy

A pressed sample was first prepared by sandwiching an adhesive sheet of Example 7 from which the protective layers had been removed, between a sample produced by using an etching treatment to remove the entire copper film from a flexible copper-clad laminate of the Example 2, and an aforementioned polyimide film B, and then bonding the layers together using a press device (temperature: 160° C., pressure: 50 kg/cm², time: 30 minutes). Furthermore, using a similar method, a pressed sample was also prepared by sandwiching an adhesive sheet of Comparative Example 5 from which the protective layers had been removed, between a sample produced by using an etching treatment to remove the entire copper film from a flexible copper-clad laminate of Comparative Example 2, and an aforementioned polyimide film B, and then bonding the layers together. These pressed samples were evaluated for flame retardancy (as a combination with the flexible copper-clad laminate) in the same manner as that described in the above measurement method 2-3.

TABLE 3

| | | | | | Comparative |
|---|---|---|---|---|---|
| | | | | Example 7 | Example 5 |
| <Components> | | | (Brand | | |
| | | | name) | | |
| A | Halogen-free epoxy | | Epikote | 100 | 100 |
| | resin | | 1001 | | |
| B | (1) | Thermoplastic | 03-72-23 | 1800 | |
| | | resin | | | |
| | (2) | Synthetic rubber | PNR-1H | 200 | |

| | | | | |
|---|---|---|---|---|
| | | Nipol 1072 | | 400 |
| C | Curing agent | Phenolite | 100 | 20 |
| | | J-325 | | |
| D | Curing accelerator | 2E4MZ | 20 | 4 |
| E | Phosphorus-containing | SP-703 | 400 | |
| | filler | | | |
| optional | Inorganic filler | Higilite | 400 | 160 |
| | | H43STE | | |
| other | Phosphorus-containing | SPE-100 | | 80 |
| | compound | | | |

| <Characteristics> | (Units) | | |
|---|---|---|---|
| Peel strength | N/cm | 1.6 | 0.9 |
| Solder heat resistance | ° C. | ≧330 | 280 |
| (normal conditions) | | | |
| Solder heat resistance | ° C. | 280 | ≦260 |
| (moisture absorption) | | | |
| Flame retardancy | VTM-0 | O | x |

<Evaluation>

The compositions prepared in Examples 1 and 2 satisfy the requirements of the present invention, and flexible copper-clad laminates produced using these compositions displayed excellent peel strength, solder heat resistance, and flame retardancy. The compositions prepared in Comparative Examples 1 and 2 did not include the phosphorus-containing filler (E) that represents one of the requirements of the present invention, and did not use a polyimide film that had undergone surface plasma treatment, and as a result, the flexible copper-clad laminates produced using these compositions displayed inferior performance for at least one of the characteristics of peel strength, solder heat resistance, and flame retardancy, when compared with the flexible copper-clad laminates that satisfy all of the requirements of the present invention.

The compositions prepared in Examples 3 to 6 satisfy the requirements of the present invention, and coverlay films produced using these compositions displayed excellent peel strength, solder heat resistance, flame retardancy, and anti-migration characteristics. The compositions prepared in Comparative Examples 3 and 4 did not include the phosphorus-containing filler (E) that represents one of the requirements of the present invention, and did not use a polyimide film that had undergone surface plasma treatment, and as a result, the coverlay films produced using these compositions displayed inferior performance for at least one of the characteristics of peel strength, solder heat resistance, and anti-migration characteristics, when compared with the coverlay films that satisfy all of the requirements of the present invention.

The composition prepared in Example 7 satisfies the requirements of the present invention, and an adhesive sheet produced using this composition displayed excellent peel strength, solder heat resistance, and flame retardancy. The composition prepared in Comparative Example 5 did not include the phosphorus-containing filler (E) that represents one of the requirements of the present invention, and the adhesive sheet produced using this composition displayed inferior performance in terms of any characteristics of peel strength, solder heat resistance, and flame retardancy, when compared with the adhesive sheet that satisfies all of the requirements of the present invention.

### INDUSTRIAL APPLICABILITY

A cured product produced by curing the flame retardant adhesive composition of the present invention, together with a coverlay film, an adhesive sheet, and a flexible copper-clad laminate produced using such a composition, all display excellent flame retardancy, peel strength, electrical characteristics (anti-migration characteristics), and solder heat resistance, and are also halogen-free, meaning they offer considerable promise in applications such as the production of environmentally friendly flexible printed wiring boards.

1. A flame retardant adhesive composition comprising
(A) a halogen-free epoxy resin,
(B) a thermoplastic resin and/or a synthetic rubber,
(C) a curing agent,
(D) a curing accelerator, and
(E) a phosphorus-containing filter.

2. The composition according to claim 1, wherein said component (B) is at least one polymer compound selected from the group consisting of polyester resins, acrylic resins, phenoxy resins, polyamideimide resins, epoxy resins with a weight average molecular weight of at least 1,000, and carboxyl group-containing acrylonitrile butadiene rubbers.

3. The composition according to claim 1, wherein said component (E) is a phosphate ester amide compound and/or a nitrogen-containing phosphate compound.

4. The composition according to claim 3, wherein said component (E) is a phosphate ester amide compound, and said phosphate ester amide compound is an aromatic phosphate ester amide.

5. The composition according to claim 3, wherein said component (E) is a nitrogen-containing phosphate compound, and the phosphorus content of said nitrogen-containing phosphate compound is at least 10% by mass.

6. The composition according to claim 1, wherein the quantity of the component (E) is within a range from 5 to 50 parts by mass, per 100 parts by mass of the combined quantity of the components (A) through (E), and an inorganic filler that may optionally be added to said composition.

7. An adhesive sheet, comprising a layer comprising the composition according to claim 1, and a protective layer for covering said layer.

8. A coverlay film, comprising an electrically insulating film that has undergone low-temperature plasma treatment, and a layer comprising the composition according to claim 1 provided on top of said electrically insulating film.

9. The coverlay film according to claim 8, wherein said electrically insulating film is a polyimide film.

10. The coverlay film according to claim 8, wherein said electrically insulating film that has undergone low-temperature plasma treatment is prepared by treating the surface of an electrically insulating film with an inorganic gas low temperature plasma generated by a direct current voltage or alternating current voltage of 0.1 to 10 kV in an atmosphere of an inorganic gas under the pressure within a range from 0.133 to 1,333 Pa.

11. A flexible copper-clad laminate, comprising an electrically insulating film that has undergone low-temperature plasma treatment, a layer comprising the composition according to claim 1 provided on top of said electrically insulating film, and copper foil.

12. The flexible copper-clad laminate according to claim 11, wherein said electrically insulating film is a polyimide film.

13. The flexible copper-clad laminate according to claim 11, wherein said electrically insulating film that has undergone low-temperature plasma treatment is prepared by treating the surface of an electrically insulating film with an inorganic gas low temperature plasma generated by a direct current voltage or alternating current voltage of 0.1 to 10 kV in an atmosphere of an inorganic gas under the pressure within a range from 0.133 to 1,333 Pa.
